(19) United States
(12) Patent Application Publication
(10) Pub. No.: US 2024/0359988 A1
(43) Pub. Date: Oct. 31, 2024

(54) ELECTROCHEMICAL EXFOLIATION OF GRAPHITE FOR PRODUCTION OF GRAPHENE FLAKES

(71) Applicant: Avadain LLC, Eads, TN (US)

(72) Inventors: Michael A. Miller, Helotes, TX (US); John R. Hemmerling, San Antonio, TX (US)

(21) Appl. No.: 18/645,941

(22) Filed: Apr. 25, 2024

Related U.S. Application Data
(60) Provisional application No. 63/461,969, filed on Apr. 26, 2023.

(51) Int. Cl. C01B 32/19

(52) U.S. Cl. CPC C01B 32/19; C01P 2002/82

(57) ABSTRACT

A method for producing graphene. The method includes loading an open-cell porous backbone material with particulate graphite, submersing at least part of the graphite-loaded porous backbone material in a solution, and applying a cathodic potential to the graphite-loaded porous backbone material, wherein the cathodic potential suffices to exfoliate graphene.

### CROSS-REFERENCE TO RELATED APPLICATIONS

This application claims the benefit of priority to U.S. Provisional Patent Application No. 63/461,969, filed on Apr. 26, 2023, the entire contents of which are incorporated by reference herein.

### STATEMENT REGARDING FEDERALLY SPONSORED RESEARCH OR DEVELOPMENT

This invention was made with government support under “Scale-up of Continuous Manufacturing and Productization of Graphene for Advanced Respirator and Biosensor Applications,” #2970576300-01 awarded by the National Institute of Standards and Technology (NIST). The government has certain rights in the invention.”

### TECHNICAL FIELD

This invention relates to the electrochemical exfoliation of graphite for the production of graphene flakes.

### BACKGROUND

Idealized graphene is an infinitely large, defect-free 2-dimensional material of monoatomic thickness and crystalline order composed of sp² hybridized carbon atoms arranged in a hexagonal lattice. As a practical matter, real-world graphene has a finite size, is not defect-free, and generally includes multiple stacked layers. Nevertheless, the physical properties of real-world graphene can approach the physical properties of idealized graphene.

Graphite is a three-dimensional structure that generally includes thousands of graphene sheets stacked on top of one another in an ordered sequence held in place by weak van der Waals interactions. In some instances, the area of each graphene sheet in a graphite particle is comparable to the area defined by two dimensions of the particle, with the third dimension of the particle reflecting the number of stacked graphene sheets. In other words, the entire graphite particle can be a single crystal, although this is not necessarily the case.

Graphene can be produced by a variety of different techniques, including electrochemical exfoliation. For example, well-established methods of producing graphene that do not involve electrochemical exfoliation include epitaxial growth on catalytic substrates at high temperature, chemical vapor deposition (CVD), micromechanical exfoliation, and direct sonication. These methods have significant disadvantages when compared with the potential attributes of electrochemical exfoliation, including low product yield and practical barriers to large-scale production.

As for electrochemical exfoliation, some approaches apply oxidizing chemical solutions or anodic potentials to graphite. These approaches yield an at least partially-oxidized form of graphene known as graphene oxide (GO). Although graphene oxide can be produced in relatively large quantities and is commercially available, its physical properties differ from the physical properties of idealized graphene due to the oxygen impurities and mixture of sp² and sp³ hybridized carbon. Oxygen can be removed from graphene oxide via chemical reduction or thermal processing to form graphene with improved physical properties. However, removing the oxygen requires additional processing steps, at increased cost and energy consumption. Also, oxygen removal is more difficult than the removal of hydrogen from a hydrogenated graphene.

Other approaches to electrochemical exfoliation apply a high cathodic potential (e.g.,−60 V) to graphite in an electrochemical cell. The cell generally contains a liquid electrolyte solution of an organic solvent and a supporting electrolyte salt and the anode is at an equally high anodic potential during exfoliation. The electrolyte composition aids exfoliation. Large ionic radii salts that are soluble in the electrolyte solvent intercalate between the stacked sheets of graphite and the applied potential drives cations of the electrolyte salt and those generated from the solvent at the anode to intercalate into the interlayer space of graphite. Gaseous species are formed in the interlayer space and further expand and exfoliate graphene sheets. In general, the exfoliated graphene is hydrogenated in that hydrogen atoms are bound to the defects. Thermal dehydrogenation-which occurs under relatively mild conditions-can be used to remove the defects and make the physical properties of the product closer to those of idealized graphene.

Examples of such approaches are found in WO 2021/048089 and the publication entitled “High Voltage Electrochemical Exfoliation of Graphite for High-Yield Graphene Production” (RSC Adv. 2019, 9 (50), p. 29305-29311, doi.org/10.1039/C9RA04795F), the contents of both of which are incorporated herein by reference.

### SUMMARY

System and techniques for the electrochemical exfoliation of graphite for the production of graphene flakes are described.

In one aspect, a method is for producing graphene. The method includes loading an open-cell porous backbone material with particulate graphite, submersing at least part of the graphite-loaded porous backbone material in a solution, and applying a cathodic potential to the graphite-loaded porous backbone material, wherein the cathodic potential suffices to exfoliate graphene.

This and other aspects can include one or more of the following features. The method can further include washing exfoliated graphene from the porous backbone material. The pores in the porous backbone material can be generally between 3 and 25 times larger, or between 5 and 10 times larger than a Sauter mean diameter of the graphite particles. An average largest dimension of pores in the porous backbone material can be between 0.5-2 mm and the graphite particles can have mean diameters ranging between 0.5 and 500 micrometers. The porous backbone material can have a void volume in excess of 50%, for example, in excess of 75%. A mass loading of the particulate graphite in the open-cell porous backbone material can be 0.1 to 0.3 g of graphite particles per cm³ of porous backbone material. The porous backbone material can be reticulated vitreous carbon foam. The solution can include an organic solvent and a supporting electrolyte salt.

The organic solvent can be propylene carbonate, ethylene carbonate, or dimethyl carbonate and the electrolyte salt can be tetrabutylammonium hexafluorophospate, tetrabutylammonium hexafluoroborate, tetrabutylammonium bis (trifluromethanesulfonyl) imide, or N-benzyl-N,N,N-trimethylammonium hexafluorophosphate. A membrane that permits transport of the electrolyte salt but hinders or prevents transport of the exfoliated graphene can be disposed between the graphite-loaded porous backbone material and an anode during the application of the cathodic potential. The membrane can be self-supporting. The membrane can have an average pore size of between 0.5 and 1 μm. The membrane can envelope the graphite-loaded porous backbone material in the solution. The cathodic potential can be applied relative to a doped-diamond anodic electrode that is at least partially submersed in the solution. The cathodic potential can be in excess of −40 Volts.

In another aspect, a composite electrode includes a reticulated vitreous carbon foam and graphite particles loaded within the reticulated vitreous carbon foam.

This and other aspects can include one or more of the following features. An average largest dimension of pores in the reticulated vitreous carbon foam can be between 0.5-2 mm and the graphite particles can have mean diameters ranging between 0.5 and 500 micrometers. Pores in the reticulated vitreous carbon foam can be generally between 3 and 25 times larger, or between 4 and 10 times larger than a Sauter mean diameter of the graphite particles. A mass loading of the reticulated vitreous carbon foam can be between 0.1 and 0.3 g of graphite particles per cm³ reticulated vitreous carbon foam. The vitreous carbon foam can have a void volume in excess of 50%, for example, in excess of 75%.

The composite electrode can be included in an electrode assembly that includes a membrane that permits transport of electrolytes in an organic solvent and a supporting electrolyte salt is disposed between the graphite-loaded porous backbone material and an anode during the application of the cathodic potential at the cathode relative to the anode via separate conductors, each of the conductors connected to the cathode and anode and to the respective output terminals of a DC power source.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 is a schematic representation of an electrode assembly that can be used in the electrochemical exfoliation of graphite for the production of graphene flakes.

FIG. 2 is a schematic representation of an example porous backbone material that can be used to form a composite electrode.

FIG. 3 is a schematic representation of an electrode assembly that can be used in the electrochemical exfoliation of graphite for the production of graphene flakes.

FIG. 4 is a schematic representation of an electrode assembly that can be used in the electrochemical exfoliation of graphite for the production of graphene flakes.

FIG. 5 is a schematic representation of an electrode assembly that can be used in the electrochemical exfoliation of graphite for the production of graphene flakes.

FIG. 6 includes images and Raman spectra of graphene.

FIG. 7 is a graph that contrasts the current as a function of time when using two different electrode assemblies.

Like reference symbols in the various drawings indicate like elements.

### DETAILED DESCRIPTION

As discussed above, the application of high cathodic potentials to graphite in an electrochemical cell can exfoliate graphene sheets that can be processed to have material properties that resemble those of idealized graphene.

However, these methods rely upon ongoing intimate electrical contact between the cathode and the graphite. If intercalation and separation happens to occurs at an intermediate location in a graphite particle (i.e., away from a surface of the particle), electrical contact to a portion of the particle may be lost. Indeed, the graphite particle may simply break into two particles that—without further exfoliation—retain their graphitic physical properties.

This issue can be addressed by mechanically compressing an aggregate of graphite particles or a thin disk of graphite to ensure that electrical contact is maintained and that exfoliation can proceed over as large a fraction of the graphite as possible. Typically, the compression constrains the graphite feedstock to a batch processing with a two-dimensional form factor as a planar aggregate or disk of graphite is compressed, thereby limiting scalability.

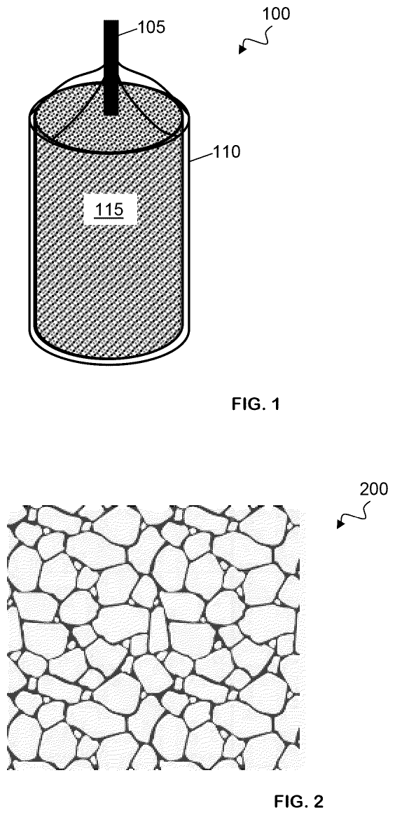

FIG. 1 is a schematic representation of an electrode assembly 100 that can be used in the electrochemical exfoliation of graphite for the production of graphene flakes. In general, electrode assembly 100 will act as the cathode in an electrochemical cell, but implementations where electrode assembly 100 acts as the anode are also possible. In general, the electrochemical cell need only be a two-electrode cell, although three-and four-electrode electrochemical cells with reference and sense electrode(s) are possible. As an aside, an “electrode” in a two-electrode cell can include multiple instances of electrode assembly 100. In other words, multiple instances of electrode assembly 100 can be coupled together electrically and act as a single electrode in an two-electrode cell.

Electrode assembly 100 includes a lead connection 105, a membrane 110, and a composite electrode 115. Lead connection 105 is a site that is configured for electrical connection to an electrical lead. The illustrated implementation of lead connection 105 is embedded within and extends into composite electrode 115 and acts as a robust, low-resistance path for electrons. Other implementations are possible. For example, lead connection 105 can be clamped or otherwise be mechanically secured to an outer surface of composite electrode 115.

Lead connection 105 is typically metallic, although implementations with other conductors (e.g., doped diamond, graphite, carbon fiber, wax-impregnated graphite) are possible. In some implementations, lead connection 105 is made from copper.

Membrane 110 is a thin material that envelopes at least some of the surfaces of composite electrode 115 and permits the transport of solvent electrolytes and charged species across the membrane while reducing or preventing transport of exfoliated graphene.

Membrane 110 is generally chemically compatible with and wetted by the electrolyte used in the electrochemical exfoliation reaction. Membrane 110 is generally able to withstand the potentials used in the electrochemical exfoliation reaction and the products and byproducts generated during the reaction. For example, the potentials relative to the opposing anode may be between 0 and −100 volts. In some implementations, membrane 110 is formed from a material that can be used as a separator membrane in electrochemical energy storage devices. For example, in some implementations, membrane 110 may be a flexible polymeric, carbon fiber, or glass fiber sheet. For example, membrane 110 may be a 200-700 μm thick (e.g., 475 μm thick) quartz fiber sheet with an average pore size of between 0.5 and 1 μm, e.g., approximately 0.7 μm.

In the schematic representation presented in FIG. 1, the flexibility of membrane 110 is illustrated by the gathering of membrane 110 at lead connection 105, above composite electrode 115. This gathering is illustrative of the flexibility and not necessary for a functional electrode assembly 100. For example, composite electrode 115 need only be partially submersed in the exfoliation solution. As another example, composite electrode 115 can be fully submersed in exfoliation solution with the top of composite electrode 115 close to the surface such that even a membrane 110 that is flexible is able to envelope the surfaces of composite electrode 115 that are in contact with the exfoliation solution. As yet another example, membrane 110 can be clamped or otherwise mechanically supported above the exfoliation solution.

Composite electrode 115 includes a porous backbone material in which particulate graphite is embedded. The porous backbone material includes at least some open-cell pores with pore sizes that permit relevant particulate graphite to be loaded into the pores and exfoliated graphene to be removed, e.g., by washing. Although the pore size of the backbone material and the particle size of the graphite can be varied (e.g., depending on different particle feedstocks and the desired size of the exfoliated graphene), the size of the pores will generally be between 3 and 25 times larger, or between 5 and 10 times larger than the Sauter mean diameter of the particles in a particulate graphite feedstock. For example, to obtain relatively large size graphene flakes, the porous backbone material may have open pores with an average largest dimension in or near the millimeter size range (e.g., 0.5-2 mm) and the graphite particles may have mean diameters ranging between 0.5 and 500 micrometers.

Although composite electrode 115 is schematically illustrated as generally cylindrical in shape, other shapes (e.g., rectangular or square cuboids, tubular, pyramidal) are possible and may be preferred in certain electrochemical cell geometries.

The porous backbone material of composite electrode 115 generally exhibits chemical compatibility with and is wetted by the electrolyte used in the electrochemical exfoliation reaction. The porous backbone material of composite electrode 115 is also generally inert and able to withstand the potentials used in the electrochemical exfoliation reaction and the products and byproducts generated during the reaction. The porous backbone material of composite electrode 115 is generally robust enough to withstand reasonable handling after loading with particulate graphite. For example, the porous backbone material of composite electrode 115 will not only be able to support the weight of the reactants and products during the electrochemical exfoliation reaction, but in general the porous backbone material will allow, e.g., composite electrode 115 to be moved into and from a reaction vessel and washed to remove exfoliate graphene without breakage.

In general, the porous backbone material is electrically conductive. During exfoliation, electrical conductivity in the porous backbone material provides multiple uninterrupted electrical paths through composite electrode 115 to improve yield.

In general, it is desirable to load the porous backbone material in composite electrode 115 with as much particulate graphite as reasonable for a given exfoliation. Porous backbone material with high void volumes are thus generally preferred. For example, void volumes in excess of 50% or in excess of 75% are preferred. In some implementations, between 0.1 and 0.3 gram of particulate graphite can be loaded into

1 cm³ of porous backbone material.

FIG. 2 is a schematic representation of an example porous backbone material 200 that can be used to form composite electrode 115. As illustrated, porous backbone material 200 forms a three-dimensional network of connected pores that are suited for loading by particulate graphite and recovering exfoliated graphene. A relatively high void volume allows relatively large amounts of particulate graphite to be loaded and exfoliated at the same time.

In some implementations, a compressive force may be applied to backbone material 200 after loading and during exfoliation. However, this is not necessarily the case. Rather, if the loading is sufficiently high, electrically conductivity in backbone material 200 can ensure that even small graphite particles can be appropriately biased and participate in the exfoliation reaction.

In some implementations, porous backbone material is a reticulated vitreous carbon (RVC) foam. Vitreous carbon is a non-graphitizing carbon with physical properties that are suitable for use as a porous backbone material 200 in composite electrode 115. Table 1 below presents typical physical properties of reticulated vitreous carbon foam.

TABLE 1

| Property | Value | |
|---|---|---|
| Compressive Strength | 0.10-0.52 | MPa |
| Tensile Strength | 0.17-0.35 | MPa |
| Young's Modulus | 102 | MPa |
| Shear Modulus | 30 | MPa |
| Specific Heat | 1.26 | J/g · ° C. |
| Thermal Conductivity (bulk) | 0.033-0.050 | W/m · ° C. |
| Electrical Resistivity (bulk) | 32.3 × 10⁻² | ohm · cm |
| Coefficient of Thermal | 2.2 | ppm/° C. |
| Expansion (0-100° C.) | | |

| | |
|---|---|
| Thermal Limits in Air [inert] | 315° C. [3499° C.] |
| Chemical/Corrosion Resistance | Inert to a wide range of |
| | reactive acids, bases, and |
| | organic solvents |

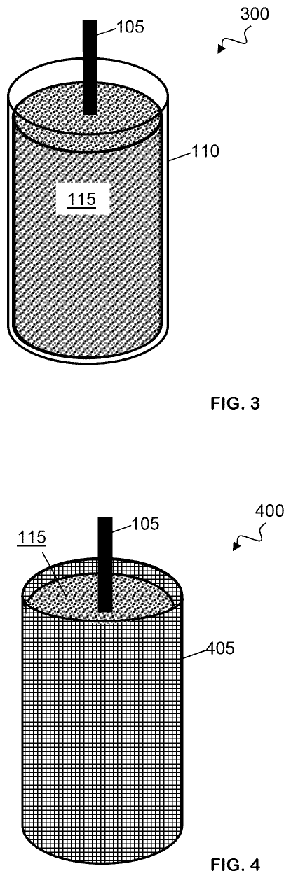

FIG. 3 is a schematic representation of an electrode assembly 300 that can be used in the electrochemical exfoliation of graphite for the production of graphene flakes. Electrode assembly 300 shares many of the features with electrode assembly 100 (FIG. 1). However, in contrast with electrode assembly 100, membrane 110 is a self-supporting membrane and able to maintain its shape. In the schematic representation presented in FIG. 3, the self-support of membrane 110 is illustrated by the extension of membrane 110 above composite electrode 115. This is illustrative and not necessary for a functional electrode assembly 300.

The shape and dimensions of a self-supporting membrane 110 and composite electrode 115 can be tailored to achieve a desired spacing between the outer surface(s) of composite electrode 115 and the inner surface(s) of self-supporting membrane 110. For example, in the illustrated implementation in which composite electrode 115 is generally cylindrical in shape, the inner surfaces of a self-supporting membrane 110 can define a cylindrically-shaped void that is dimensioned to envelope the composite electrode 115. In some implementations, the shape and dimensions of a self-supporting membrane 110 can be selected to maintain a relatively small distance between the outer surface(s) of composite electrode 115 and the inner surface(s) of self-supporting membrane 110. For example, distances of 0 to 5 mm can be maintained. For example, the outer surface(s) of composite electrode 115 and the inner surface(s) of self-supporting membrane 110 can be considered “in contact” when at least a portion of the surfaces touch and the largest separation distance between portions that do not touch is within a tolerance of 0.5 mm.

FIG. 4 is a schematic representation of an electrode assembly 400 that can be used in the electrochemical exfoliation of graphite for the production of graphene flakes. Electrode assembly 400 shares many of the features with electrode assemblies 100, 300 (FIGS. 1, 3). However, in contrast with electrode assemblies 100, 300, electrode assembly 400 includes a self-supporting porous material that envelopes composite electrode 115 and acts as membrane 110.

In some implementations, the porous backbone material 405 is a relatively thin reticulated vitreous carbon foam. For example, in some implementations, the thickness of porous backbone material 405 can be less than or equal to 20%, or less than or equal to 10% of the largest dimension of composite electrode 115. As another example, in some implementations, the porosity of the reticulated vitreous carbon foam in porous backbone material 405 can be tailored to hinder or prevent transport of exfoliated graphene.

The use of reticulated vitreous carbon foam as porous backbone material 405 provides some advantages. For example, reticulated vitreous carbon foam is chemically compatible with and wetted by exfoliation electrolyte and able to withstand the exfoliation reaction. Also, reticulated vitreous carbon foam is generally mechanically robust and can be reused many times in the electrochemical exfoliation of graphite. An example of a suitable RVC foam is available under the name DUOCEL® from ERG Aerospace Corporation (Oakland, CA).

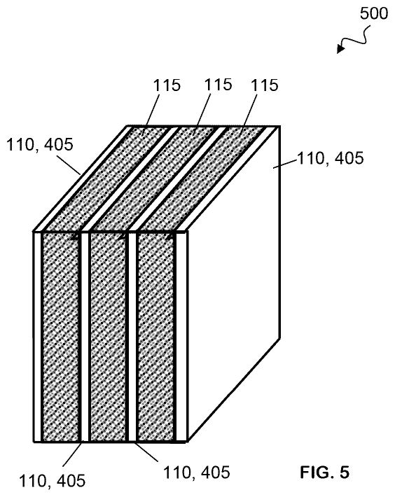

FIG. 5 is a schematic representation of an electrode assembly 500 that can be used in the electrochemical exfoliation of graphite for the production of graphene flakes. Electrode assembly 500 shares many of the features with electrode assemblies 100, 300, 400 (FIGS. 1, 3, 4). However, electrode assembly 500 includes a stacked structure of alternating composite electrodes 115 and either/both of membrane 110 and porous backbone materials 405. In the illustrated implementation, composite electrodes 115 and membranes 110/porous backbone materials 405 are illustrated as a stack of uniformly-sized rectangular cuboid sheets without space between them. In other implementations, the shapes and/or sizes of composite electrodes 115 and membranes 110/porous backbone materials 405 can be varied. In some implementations, the transport of exfoliation solution into the interior of electrode assembly 500 can be facilitated, e.g., either by separating or defining channels between or within composite electrodes 115 and membranes 110/porous backbone materials 405 and/or through active transport (pumping).

In some implementations, the exfoliation solution can include a salt composed of large ions, such as tetrabutylammonium hexafluorophospate, tetrabutylammonium hexafluoroborate, tetrabutylammonium bis (trifluromethanesulfonyl) imide or N-benzyl-N,N,N-trimethylammonium hexafluorophosphate, dissolved in an organic carbonate solvent, such as propylene carbonate, ethylene carbonate, or dimethyl carbonate. Concentrations of these exemplary salt solutions may range between 0.01 and 0.5 M.

### EXAMPLE RESULTS

Example 1: The electrochemical cell included a freestanding boron-doped diamond anode (2.5 cm×5 cm) and a cathode formed by an electrode assembly with a rectangular cuboid composite electrode and flexible membrane. The composite electrode included a reticulated vitreous carbon porous backbone material loaded with 250 mg of graphite flakes. Both the composite electrode and the boron-doped diamond anode were submerged in electrolyte solution to a depth slightly below the connection for their respective leads and separated from each other by a distance of approximately 2 cm. The electrolyte solution included 0.1 M tetrabutylammonium hexafluorophosphate [CH₃CH₂CH₂CH₂)₄N (PF₆), TBA-PF₆] in propylene carbonate [C₄H₆O₃, PC]. The electrolyte solution was deaerated with argon prior to use and the entire electrochemical cell was sealed in a glass vessel and purged with argon.

The cathode assembly and the boron-doped diamond anode were connected to a 600 W constant-current/constant-voltage DC power supply via an insulated copper wire conductor, with the cathode assembly polarized negatively relative to the boron-doped diamond anode. Using the constant voltage mode of the power supply, the voltage applied to the cathode assembly was ramped to −60 V versus the boron-doped diamond anode at a rate of approximately 3 V/min while current was monitored. This target voltage was maintained across the cell for a period of 24 hours.

The exfoliation reaction proceeded vigorously during the voltage ramp and the current and temperature increased markedly. Clouds formed within the argon-purged reaction vessel of the cell. The clouds are a mixture of electrolyte volatiles and hydrogen gas generated at the cathode assembly. The current across the cell was observed to reach a maximum value within approximately 30 min, after which time it decayed exponentially until the reaction was terminated. Concurrently, the volume of the cathode assembly increased significantly as the exfoliation product, hydrogenated graphene, was formed.

After the reaction was terminated, the cathode assembly was removed from the electrochemical cell and the product was recovered from the reticulated vitreous carbon porous backbone and separator membrane, washed several times with acetone using a vacuum filtration apparatus, and dried in air. The graphene was thermally dehydrogenated in a tube furnace under vacuum at 600° C. for one hour.

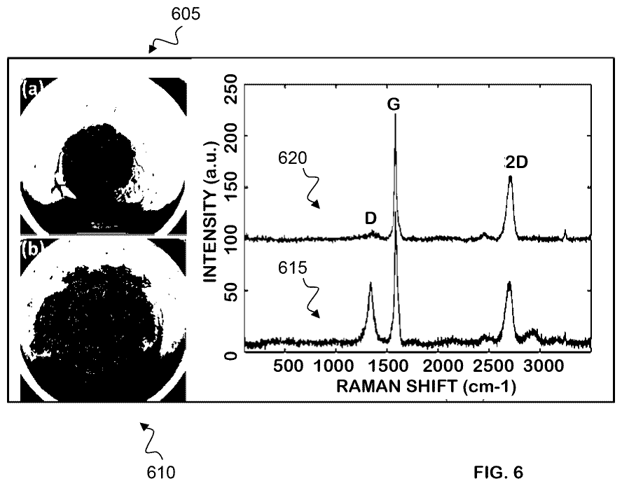

FIG. 6 includes an image 605 of the hydrogenated graphene after recovering from the reticulated vitreous carbon porous backbone, an image 610 of the graphene after dehydrogenation, a Raman spectrum 615 of the hydrogenated graphene, and a Raman spectrum 620 of the dehydrogenated graphene.

In Raman spectra 615, 610, the phonon mode labeled “D” near 1360 cm⁻¹ corresponds to a well-known disorder-induced mode that emerges in graphite crystallites with short-range crystalline order. The mode labeled “G” near 1580 cm⁻¹ corresponds to the in-plane displacement phonon mode (E_{2g2}) that occurs within graphene sheets in a graphite crystallites or in graphene alone. The mode labeled “2D” near 2730 cm⁻¹ corresponds to a second-order mode of the disorder-induced D line in graphite crystallites (i.e., overtone of the maxima in the phonon density of states at 1360 cm⁻¹). This second order mode is sensitive to cumulative disorder in the stacked graphene sheets of graphite crystallites and becomes asymmetric in shape when the number of disordered stacked sheets is greater than five.

Graphene in the absence of graphite exhibiting long-range crystalline order is characterized by Raman spectra that display a small or nonexistent D line and a sharp G line with minimal broadening; that is, the D/G intensity ratio would be small.

Furthermore, the 2D line would be highly symmetric if the number of stacked graphene sheets were less than five, or nonexistent if the synthesis product contained only graphene of monoatomic thickness.

As shown in spectrum 615, the hydrogenated graphene exhibits a significant D line due to the disorder produced by sp³ carbon centers in the exfoliated graphene sheets.

In contrast, in spectrum 620 of the dehydrogenated graphene, the D line is nearly nonexistent and the 2D line is highly symmetric. These spectral characteristic indicate that the final graphene product is both very pure and on average consists of only a few stacked sheets.

Example 2: The electrochemical cell included a freestanding boron-doped diamond anode (2.5 cm×5 cm) and a cathode formed by an electrode assembly with a cuboid composite electrode and self-supporting membrane structure shaped like a thimble, open at the top and closed at the bottom. The composite electrode included a reticulated vitreous carbon porous backbone material loaded with 500 mg of graphite. Both the composite electrode and the boron-doped diamond anode were submerged in electrolyte solution to a depth slightly below the connection for their respective insulated copper wire leads and separated from each other by a distance of approximately 2 cm. The same electrolyte solution as in Example 1 was employed. The electrochemical exfoliation reaction was carried out under the same polarization conditions as well.

The reaction proceeded more vigorously than in Example 1 during the voltage ramp up to −60 V, with higher currents and larger temperature increases. Clouds were again generated within the argon-purged electrochemical cell.

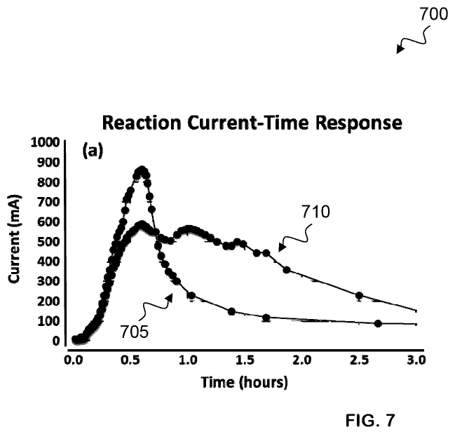

FIG. 7 is a graph 700 that contrasts the current as a function of time in Example 1 and Example 2. In graph 700, position along the x-axis represents time in hours, whereas position along the y-axis represents the current in mA. Curve 705 shows the reaction current as a function of time during Example 1. Curve 710 shows the reaction current as a function of time during Example 2.

As shown, the peak current during Example 2 was lower than during Example 1, notwithstanding the large quantity of graphite. However, the total charge transfer (i.e., the integral of the current-time response) for Example 2 was approximately twice the total charge transfer for Example 1, commensurate with the mass loading of graphite in the composite cathode being twice as high. This is believed to indicate that the electrochemical exfoliation reaction is scalable.

A number of embodiments have been described. Nevertheless, it will be understood that various modifications may be made. Accordingly, other embodiments are within the scope of the following claims.

What is claimed is:

1. A method for producing graphene, the method comprising:
loading an open-cell porous backbone material with particulate graphite;
submersing at least part of the graphite-loaded porous backbone material in a solution; and
applying a cathodic potential to the graphite-loaded porous backbone material, wherein the cathodic potential suffices to exfoliate graphene.

2. The method of claim 1, further comprising washing exfoliated graphene from the porous backbone material.

3. The method of claim 1, wherein pores in the porous backbone material are generally between 3 and 25 times larger, or between 5 and 10 times larger than a Sauter mean diameter of the graphite particles.

4. The method of claim 1, wherein an average largest dimension of pores in the porous backbone material is between 0.5-2 mm and the graphite particles have mean diameters ranging between 0.5 and 500 micrometers.

5. The method of claim 1, wherein the porous backbone material has a void volume in excess of 50%, for example, in excess of 75%.

6. The method of claim 1, wherein a mass loading of the particulate graphite in the open-cell porous backbone material is 0.1 to 0.3 g of graphite particles per cm³ of porous backbone material.

7. The method of claim 1, wherein the porous backbone material is reticulated vitreous carbon foam.

8. The method of claim 1, wherein the solution comprises an organic solvent and a supporting electrolyte salt.

9. The method of claim 8, wherein:
the organic solvent is propylene carbonate, ethylene carbonate, or dimethyl carbonate; and
the electrolyte salt is tetrabutylammonium hexafluorophospate, tetrabutylammonium hexafluoroborate, tetrabutylammonium bis (trifluromethanesulfonyl) imide, or N-benzyl-N,N,N-trimethylammonium hexafluorophosphate.

10. The method of claim 8, wherein a membrane that permits transport of the electrolyte salt but hinders or prevents transport of the exfoliated graphene is disposed between the graphite-loaded porous backbone material and an anode during the application of the cathodic potential.

11. The method of claim 10, wherein the membrane is self-supporting.

12. The method of claim 10, wherein the membrane has an average pore size of between 0.5 and 1 μm.

13. The method of claim 10, wherein the membrane envelopes the graphite-loaded porous backbone material in the solution.

14. The method of claim 1, wherein the cathodic potential is applied relative to a doped-diamond anodic electrode that is at least partially submersed in the solution.

15. The method of claim 1, wherein the cathodic potential is in excess of −40 Volts.

16. A composite electrode comprising:
a reticulated vitreous carbon foam; and
graphite particles loaded within the reticulated vitreous carbon foam.

17. The composite electrode of claim 16, wherein an average largest dimension of pores in the reticulated vitreous carbon foam is between 0.5-2 mm and the graphite particles have mean diameters ranging between 0.5 and 500 micrometers.

18. The composite electrode of claim 16, wherein pores in the reticulated vitreous carbon foam are generally between 3 and 25 times larger, or between 4 and 10 times larger than a Sauter mean diameter of the graphite particles.

19. The composite electrode of claim 16, wherein a mass loading of the reticulated vitreous carbon foam is between 0.1 and 0.3 g of graphite particles per cm³ reticulated vitreous carbon foam.

20. The composite electrode of claim 16, wherein the reticulated vitreous carbon foam has a void volume in excess of 50%, for example, in excess of 75%.

21. The composite electrode of claim 16, wherein the composite electrode is included in an electrode assembly that includes a membrane that permits transport of electrolytes in an organic solvent and a supporting electrolyte salt is disposed between the graphite-loaded porous backbone material and an anode during the application of the cathodic potential at the cathode relative to the anode via separate conductors, each of the conductors connected to the cathode and anode and to the respective output terminals of a DC power source.
